(19) United States
(12) Patent Application Publication
(10) Pub. No.: US 2011/0297109 A1
(43) Pub. Date: Dec. 8, 2011

(54) KISS Canine Collar Band

(76) Inventor: Roseanna Lynn Petty, Morrisville, NC (US)

(21) Appl. No.: 12/792,426

(22) Filed: Jun. 2, 2010

(51) Int. Cl. A01K 27/00

(52) U.S. Cl. 119/858; 119/856

(57) ABSTRACT

A dog “canine” collar manufactured as a continuous band of 100% silicone designed to stretch over the dogs head then revert to its original size once placed around its neck thereby providing proper, comfortable fit.

### BACKGROUND OF THE INVENTION

The present invention relates to a functional elastic non-buckle dog collar comprised of 100% silicone capable of displaying identification or decorative information via silicone printing methods.

The invention includes a functional safety feature, providing night time visibility, when manufactured with colors which contain glowing agents. This eliminates the need for LED display electronics, or reflective devices, and does not require a reflecting light, such as an automobile headlight, to glow.

### SUMMARY OF THE INVENTION

A dog “canine” collar composed of 100% silicone. It's purpose is to provide a “slip-on” identification collar that comfortably and properly fits around the dogs neck due to it's ability to stretch. The collar will stay in place and cannot come apart as a result of a buckle.

The products material, silicone, has an inherent elastic property allowing the collar's circumference to temporarily expand to stretch over the dogs head, then revert to it's original size and shape after being stretched. The amount of elasticity (stretch) can be modified by increasing or decreasing the thickness, length, and width of the band.

The products material, silicone, is waterproof, eliminating the need to dry for hours if it becomes wet (as observed with nylon collars); durable, eliminating the extensive care requirements (observed with leather collars); and easy to clean with gentle soap and water.

The collar may feature designs (silk screened, swirled colors), and/or text (embossed, debossed, or silk-screened). Specific colors support the addition of a glowing agent. Collars manufactured with these colors provide visibility at night.

### BRIEF DESCRIPTION OF THE DRAWINGS

FIG. 1: shows the band without a buckle

FIG. 2: shows the dimensions

FIG. 3: alternate view of the dimensions

FIG. 4: shows prototype designs

FIG. 5: shows one of the manufactured KISS Canine Collar Band prototypes on a dog

FIG. 6: shows an example of an optional tag attachment

FIG. 7: enlarged view of an optional tag attachment

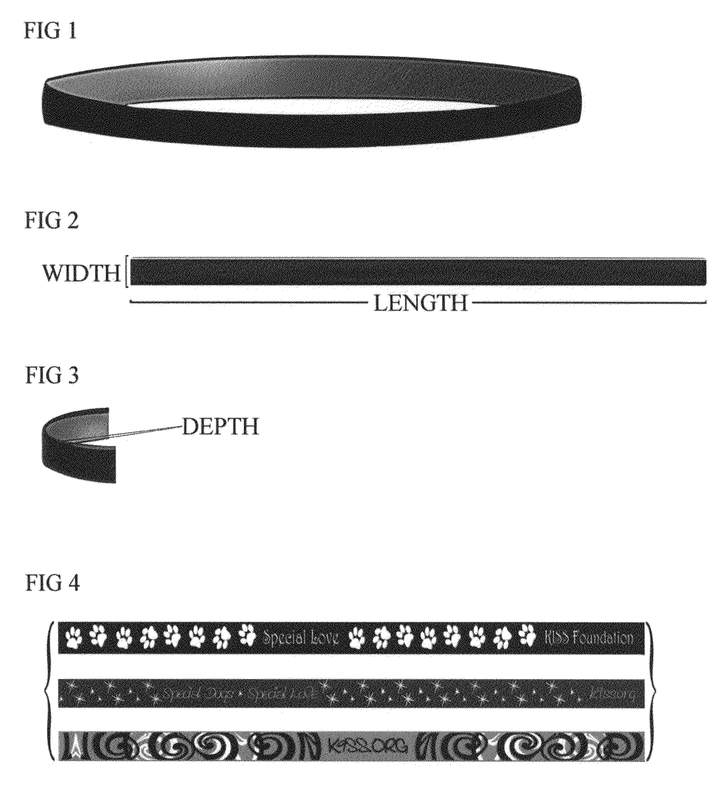

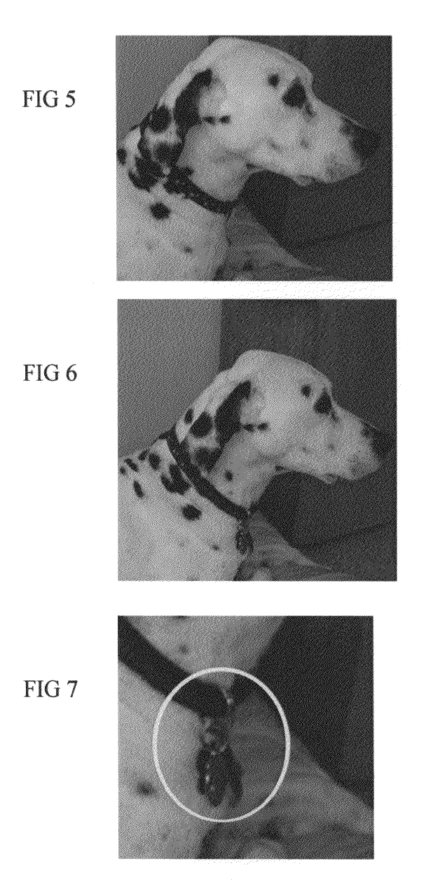

I claim:

1. A dog “canine” collar comprised of a continuous band of 100% silicone designed to provide enough elasticity to stretch over the dogs head and fit comfortably around the neck.

2. The dog “canine” collar as defined in claim 1, supports standard dog collar dimensions.

3. The dog “canine” collar as defined in claim 1, will equal the circumference of the dogs neck within the closest two inch increment.

4. The dog “canine” collar as defined in claim 1, wherein said silicone, supports custom decorative design.

5. The dog “canine” collar as defined in claim 1, wherein said silicone, supports custom functional design.
